(19) United States
(12) Patent Application Publication
(10) Pub. No.: US 2026/0335970 A1
(43) Pub. Date: Oct. 29, 2026

(54) DEGASSER SHAFT

(71) Applicant: FOSECO INTERNATIONAL LIMITED, London (GB)

(72) Inventors: James Crowley, Gloucestershire (GB); Inigo Anza, Berkatal-Frankenhain (DE); Peter Braun, Berkatal-Frankenhain (DE); Tarik Goenen, Berkatal-Frankenhain (DE); Nitin Kawale, Aurangabad (IN); Vic Shao, Suzhou, Jiangsu (CN)

(73) Assignee: FOSECO INTERNATIONAL LIMITED, London (GB)

(21) Appl. No.: 19/110,694

(22) PCT Filed: Sep. 15, 2023
(86) PCT No.: PCT/EP2023/075419

§ 371 Date: Mar. 11, 2025

(30) Foreign Application Priority Data
Sep. 16, 2022 (IN) 202211053037
Nov. 10, 2022 (GB) 2216738.1

(51) Int. Cl. B22D 27/00; B22D 21/04

(52) U.S. Cl. CPC B22D 27/003; B22D 21/04

(57) ABSTRACT

A degasser shaft for treating a molten metal with a gas comprises a first end connectable to a drive for rotation of the shaft about a longitudinal axis, the first end having a first end external diameter; a second end having a second end external diameter and either connectable to a rotor; or integral with a rotor, the second end external diameter being deemed to be a minimum shaft external diameter proximal to the rotor; and a passage through which the gas travels from the first end to the second end, the passage defined by an internal diameter of the degasser shaft, wherein the degasser shaft has a first portion located at, or towards the first end and comprising a first tapered segment decreasing in cross-sectional area towards the second end, and wherein at least the first tapered segment of the degasser shaft consists of a ceramic composite material.

### CROSS-REFERENCE TO RELATED APPLICATIONS

This application is the National Stage entry of PCT/EP2023/075419, filed on Sep. 15, 2023, which claims priority from India application number 202211053037 filed Sep. 16, 2022 and United Kingdom application number 2216738.1 filed Nov. 10, 2022, the disclosures of which are hereby incorporated by reference in their entirety.

### FIELD OF THE INVENTION

The invention relates to degassing shafts; the use of the degassing shafts to degas molten metals and, in particular, molten aluminium, magnesium, and alloys thereof.

### BACKGROUND

In the degassing process, inert gases are pumped into aluminum melts to remove hydrogen and prevent subsequent porosity in cast parts. In a rotary degassing method, an inert or chemically inactive gas is purged through a rotating shaft and rotor. The energy of the rotating shaft and rotor causes formation of a large number of fine bubbles providing a very high surface area to volume ratio.

The large surface area promotes fast and effective diffusion of hydrogen into the gas bubbles resulting in equalizing activity of hydrogen in liquid and gaseous phases and rapid removal of hydrogen from the melt.

There are a variety of degassing procedures many of which require the shafts to rotate at high speeds which results in vibration and high frequency cyclic bending loading and stress being placed upon the shafts, concentrated in the end part towards the motor connection. Graphite and carbon composite shafts have been favoured for these types of applications due to their low density, high stiffness and superior flexural strength compared to shafts made from ceramic composite materials. However, graphite shafts while having good mechanical properties for these applications, are prone to oxidative corrosion and mechanical erosion in contact with the air atmosphere and the molten metal respectively, resulting in graphite shafts having to be replaced on a regular basis.

EP3180455, in the name of Pyrotek Inc., addresses this problem through the carbon composite element being impregnated with an oxidation resistant chemical, such as phosphate based oxidation retardants disclosed in U.S. Pat. No. 4,439,491.

WO2022/129612, in the name of Foseco International Limited, is directed to the demanding problem of injecting metal additives into molten iron, and uses a gas to carry the metals in the form of powder into the molten iron, the gas pressure preventing iron passing back into a rotor shaft.

WO2022/129612 places a ceramic composite sleeve over a graphite shaft (which would otherwise dissolve in molten iron), such that the graphite shaft can provide good mechanical properties, whilst the ceramic composite can provide improved oxidative corrosion and erosion resistance. The graphite shaft and ceramic composite sleeve are tapered to enable a tight fit between the graphite shaft and ceramic composite sleeve. However, the coefficient of thermal expansion mismatch between the graphite shaft and ceramic composite sleeve can result in a deterioration of the integrity of the seal between the shaft and the sleeve, thereby shortening the working life of the shaft/sleeve combination.

WO2004/029307A1 discloses a degasser shaft that tapers towards the rotor head. The peripheral speed of the shaft in the molten metal thus decreases with increasing depth which is alleged to minimize unwanted vortices. WO2004/029307A1 does not define the material of the shaft.

Despite these advances, there is still a need for improved degasser shafts with a longer working life; able to be manufactured without complexity in materials or processes; and which are able to be used in high frequency cyclic loading or stress applications, also known as fatigue applications.

### SUMMARY OF THE INVENTION

In a first aspect of the present invention there is provided a degasser shaft for treating a molten metal with a gas, the shaft comprising:
(a) a first end connectable to a drive for rotation of the shaft about a longitudinal axis, the first end having a first end external diameter;
(b) a second end having a second end external diameter and either:
connectable to a rotor; or
integral with a rotor, the second end external diameter being deemed to be a minimum shaft external diameter proximal to the rotor; and
(c) a passage through which the gas travels from the first end to the second end, the passage defined by an internal diameter of the degasser shaft;

wherein the degasser shaft has a first portion located at, or towards the first end and comprising a first tapered segment decreasing in cross-sectional area towards the second end, and optionally a first constant section segment (having a constant cross-sectional area) extending from the first tapered segment towards the first end, said first portion comprising between 48% and 100% of the total length of the degasser shaft; and wherein at least the first tapered segment of the degasser shaft consists of a ceramic composite material.

By “tapered” is meant decreasing in cross sectional area, and the decrease may be linear or smooth, for example flaring from a first cross sectional area to a second cross sectional area so as to approach the first cross sectional area and/or second cross sectional area smoothly.

The tapered segment is preferably frustoconical. The constant section segment is preferably cylindrical.

In some embodiments, the degasser shaft further comprises one or both of:
a first constant section segment (having a constant cross-sectional area) with a cross sectional area greater than a minimum cross-sectional area of the degasser shaft and contiguously extending from the first tapered segment towards the first end; and
a second constant section segment (having a constant cross-sectional area) contiguously extending from the first tapered segment towards the second end.

In some embodiments, the shaft consists of the first portion and the optional second constant section segment. The first portion may comprise a tapered segment comprising tapered segments with optional constant segments having a cross sectional area greater than the minimum cross-sectional area of the degasser shaft (e.g. a first cylindrical segment and intermediate cylindrical segments disposed between frustoconical shaped segments).

The degasser shafts of the present invention have a long working life due to the shaft being both resistant to oxidative corrosion, melt mechanical erosion and premature mechanical failure. Whilst the innovative design features may be applied to any material suitable for use as a degasser shaft, the degasser shafts are particularly advantageous when made of a ceramic composite. It is counter-intuitive that the objective of an extended working life may be improved using a composite material having generally lower flexural fatigue strength than graphite-based compositions.

The tapered (e.g. frustoconical shaped) portion may comprise one or more tapered segments which make up at least 50% or at least 60% or at least 70% or at least 80% or at least 90% or 100% of the total length of the first portion. The tapered segment may comprise one or more tapered segments and intermediate constant section segments (excluding the first or second constant section segments) which make up at least 50% or at least 60% or at least 70% or at least 80% or at least 90% or 100% of the total length of the degasser shaft. In some embodiments, the one more tapered segments make up no more than 90% or no more than 80% or no more than 70% or no more than 60% of the total length of the degasser shaft. The longer the one or more tapered segments, the lower the incident angle from the shaft axis, thereby avoiding localised stress concentrations, if and, when the tapered segment abuts an optional constant section segment of the degasser shaft.

For the purposes of the present invention the constant section segment(s) are in inclusive of a cylindrical and polygonal prism or any other suitable shaped portion with a constant cross-sectional area. In some embodiments, the constant section segment comprises a cylinder. In other embodiments, the constant section segment comprises a prismatic polygon, preferably with a least 5 sides and preferably at least 7 or at least 8 sides. In embodiments where the constant segment comprises a polygonal prism (e.g. a hexagonal prism), the constant section segment may function, in cooperation with a fastening tool (e.g. spanner) to fasten the degasser shaft to the motor or rotor, or connection thereof. Preferably, the constant section segment does not include any acute angles (e.g. less than 900 or less than 60°), so to avoid any stress concentration points within the shaft (e.g. a pentagon or hexagonal). The constant portion is preferably symmetrical around a central axis of the degasser shaft. In some embodiments, the constant section segment comprises a degasser shaft cross sectional area at least 5% or at least 8% or at least 10% or at least 12% or at least 15% or at least 20% greater than the minimum cross-sectional area of the degasser shaft proximal or at the second end.

The first portion may comprise at least 50% or at least 52% or at least 55% or at least 58% or at least 60% or at least 70% or at least 80% or at least 90% or at least 95% or 100% of the total length of the degasser shaft. In some embodiments, the first portion may be no more than 90% or no more than 80% or no more than 70% or no more than 60% of the total length of the degasser shaft. A larger first portion may assist in minimising localised areas of concentrated stress during operation and increase shaft stiffness, whilst a smaller first portion may enable a reduction in shaft weight.

The first constant segment, when present, may represent >0% to 50%; or 5% to 40%; or 10% to 30% of the total length of the shaft. Typically, the first constant segment is a least 5 mm or at least 10 mm or at least 20 mm. The first constant segment is typically no more than 1000 mm or no more than 800 mm or no more than 600 mm or no more than 500 mm or no more than 400 mm. In some embodiments, the first constant segment comprises the melt-line of the shaft.

When the first portion does not extend the entire length of the shaft, the remainder of the shaft, which is not part of the first portion, may comprise a second constant segment (including a cylinder or polygonal prism segment) defined by the second end diameter and extending from the first portion to the second end. The second end external diameter is typically the minimum diameter (or effective diameter) of the shaft.

The second constant segment, when present, may represent >0% to 52% of the total length of the shaft. Typically, the second constant segment is a least 5 mm or at least 10 mm or at least 20 mm or at least 40 mm or at least 60 mm. The first constant segment is typically no more than 1000 mm or no more than 800 mm or no more than 600 mm or no more than 500 mm or no more than 400 mm.

The first shaft end external diameter is typically the maximum external diameter of the shaft. In some embodiments, the first shaft end external diameter defines a first constant segment of the shaft which extends from the end of the tapered segment towards the first end of the shaft.

In other embodiments, the first portion comprises two or more tapered sections which connect the first shaft end diameter to the second shaft end external diameter. The tapered sections may progressively decrease in external diameter as they progress towards the second end of the shaft.

Each of the tapered sections may be separated by one or constant segments. The benefit of this “step down” configuration is that the shaft external diameter (and hence stiffness) of sections of the shaft may be customised to counter localised vibration and therefore stress along the degasser shaft under the conditions of operation.

In some embodiments, a first constant segment extends to the first end of the shaft.

A motor guard or housing associated with the motor may be such that the external diameter of the first end is required to be smaller than the maximum external diameter of the shaft to enable the first shaft end to fit within such auxiliary components of the degasser system. In these embodiments, the first end external diameter may be contiguously connected to the maximum external diameter of the shaft by a tapered segment.

### Connectors and Seamless Connections

The first end of the shaft is connectable to a motor and second end of the shaft may be connectable to a rotor. The connection to the motor and/or rotor may be a male connector; a female connector; or any other suitable coupling mechanism.

In some embodiments, the first end is connectable to the motor by a female connector. The female connector may be a spiral threaded coupling means (e.g. a spiral threaded cavity). To reduce stress concentrations around the female connector, the female connector preferably comprises an arced bridging connection to the passage. The arc bridging connection preferably has a radius of at least 5 mm or at least 10 mm. The arced bridging connection may also be incorporated into a male connector.

When there is a seamless connection of the shaft to the rotor (or a flanged connection of increasing shaft diameter), the deemed second end has been taken to be a minimum diameter of the shaft proximal the rotor. This ensures that the second end point does not include any of the tapered enlargement of the apparatus towards the wider diameter of the rotor, which is typically disc shaped.

### Degasser Shaft Dimensions

The degasser shaft is preferably a monolithic construction. In some embodiments, the degasser shaft extends from the internal diameter defining the passage and extends to the external diameter. The outer surface of the degasser shaft is defined by the external diameter of the shaft. In operation, the outer surface of the degasser shaft is in contact with the molten metal in the immersed region and hot air atmosphere in the nearby non-submerged region, with thickness of the degasser rotor (i.e. outer shaft diameter−internal shaft diameter) providing superior oxidative corrosion and erosion resistance compared to graphite shafts of the same thickness along or in combination with oxidative corrosion resistant protective sleeve. The superior oxidative and erosion corrosion resistance may also enable the shaft walls to be thinner to lighten the shaft weight, while maintaining sufficient oxidative corrosion and erosion resistance.

The length of the degasser shaft is measured along the central axis from the first end to the second end. The length does not include extensions attributable to connectors, such as male connectors. When the second end of the degassing shaft comprises a rotor (i.e. the rotor is integral to the shaft or seamlessly connected (e.g. a monolithic construction)), the second end is deemed to terminate where the minimum shaft diameter is located closest to the rotor. Therefore, tapered flange components which increase in diameter towards the end of the shaft to match the diameter of the rotor are not included in the calculation of the shaft length.

Degasser shafts typically range in length from at least 250 mm to no more than 2500 mm and typically no more than 2200 mm or no more than 2000 mm. The length of the shaft may be determined by the requirements of the degassing system. However, the vibrations derived stresses on degasser shafts significantly increase and shorten their durability once the shaft length extends to 2000 mm and beyond at the specified rotational speeds.

Degasser shaft may be categorised into three categories as indicated in Table 1 below:

TABLE 1

| | Lengthₘᵢₙ | Lengthₘₐₓ | | |
|---|---|---|---|---|
| Type | (mm) | (mm) | RPMₘᵢₙ | RPMₘₐₓ |
| Short | 250 | 600 | 500 | 1000 |
| Medium | 600 | 1500 | 300 | 700 |
| Long | 1500 | 2500 | 150 | 600 |

As indicated in Table 1, as the degasser shaft lengthens, the rotation speeds they operate under decreases. This is at least partially related to the increasing rotor-dynamics instability for increasing rotation speed in longer shafts, which translates into additional stresses placed upon longer degasser shafts.

For long shafts, the maximum external diameter (Dₘₐₓ) of the shaft is typically between 125 mm to 200 mm. In some embodiments, the maximum external diameter is at least 130 mm or at least 140 mm or at least 150 mm or at least 160 mm. The larger the diameter for constant cross section weight, the higher the cross section moment of inertia and the stiffer the shaft at that location. The minimum external diameter (Dₘᵢₙ) of the shaft is typically between 60 mm to 150 mm. The difference between the maximum and minimum external shaft diameter (Dₘₐₓ−Dₘᵢₙ) is typically at least 20 mm or at least 25 mm or at least 30 mm or at least 35 mm or at least 40 mm or at least 45 mm or at least 50 mm or at least 55 mm or at least 60 mm. Dₘₐₓ−Dₘᵢₙ is typically no more than 150 or no more than 100 mm.

For medium shafts, the maximum external diameter (Dₘₐₓ) of the shaft is typically between 100 mm to 150 mm. In some embodiments, the maximum external diameter is at least 110 mm or at least 115 mm or at least 120 mm or at least 125 mm. The minimum external diameter (Dₘᵢₙ) of the shaft is typically between 60 mm to 120 mm. The difference between the maximum and minimum shaft external diameter (Dₘₐₓ−Dₘᵢₙ) is typically at least 20 mm or at least 25 mm or at least 30 mm or at least 35 mm or at least 40 mm or at least 45 mm or at least 50 mm. In some embodiments, Dₘₐₓ−Dₘᵢₙ is no more than 90 mm.

For short shafts, the maximum external diameter (Dₘₐₓ) of the shaft is typically between 60 mm to 100 mm. In some embodiments, the maximum external diameter is at least 65 mm or at least 70 mm or at least 75 mm or at least 80 mm. The minimum external diameter (Dₘᵢₙ) of the shaft is typically between 40 mm to 80 mm. The difference between the maximum and minimum shaft external diameter (Dₘₐₓ−Dₘᵢₙ) is typically at least 10 mm or at least 15 mm or at least 20 mm or at least 25 mm or at least 30 mm or at least 35 mm or at least 40 mm. Dₘₐₓ−Dₘᵢₙ is typically no more than 60 mm.

In some embodiments, the external diameter of the first end may be up to 100 mm or up to 50 mm smaller than Dₘₐₓ.

In some embodiments, the ratio of Dₘₐₓ to Dₘᵢₙ is at least 1.1 or at least 1.2 or at least 1.3 or at least 1.4 or at least 1.5 or at least 1.6 or at least 1.7 or at least 1.8. The ratio of Dₘₐₓ to Dₘᵢₙ is typically no more than 5 or no more than 4 or no more than 3 or no more than 2. A higher Dₘₐₓ to Dₘᵢₙ ratio promotes weight distribution towards the top (i.e. first end) of the shaft, thereby reducing the tendency of excessive vibration of the shaft during operation, lower stress and higher thickness at melt line.

In some embodiments, the ratio of the minimum shaft external diameter to the minimum wall thickness (Dₘᵢₙ/Wallₘᵢₙ) was at least 2.7 or at least 2.9 or at least 3.1 or at least 3.3. A higher ratio promotes a stiffer lighter weight shaft.

In some embodiments, the ratio of the maximum external diameter to the minimum external diameter of the degasser shaft is in the range of 1.05:1 to 3.0:1 or in the range of 1.1:1 to 2.5:1 or in the range of 1.2:1 to 2.0:1.

The maximum shaft external diameter is typically at the first end or around the melt line. The minimum shaft external diameter is typically at or around the second end of the shaft.

In some embodiments, the degassing shaft comprises an incident angle between a tapered segment and a constant section segment (or a central axis) of no more than that 160 or no more than 150 or no more than 140 or no more than 130 or no more than 120 or no more than 10°. Higher incident angles may result in a concentration of bending stresses at this intersection resulting in potential mechanical failure. The incident angle is greater than 0° and typically at least 0.3° or at least 0.5° or at least 1.0° or at least 2.0° or at least 3.0° or at least 4.0° or at least 5.0° to enable the required changes in shaft diameter to be achieved to obtain stiffness and weight objectives.

The internal diameter of the shaft (i.e. passage) may range from 10 mm to 80 mm or 12 mm to 70 mm or 15 mm to 60 mm or 18 mm to 50 mm or 20 mm to 40 mm. In some embodiments, the internal diameter of the shaft is at least 25 mm or at least 30 mm or at least 40 mm. A larger internal diameter enables one or both of a larger external diameter and a thinner wall thickness. A larger external diameter contributes to a stiffer shaft for a constant cross-sectional weight, while thinner walls contribute to a lower degasser shaft weight. The internal diameter may be constant along the length of the shaft or the internal diameter may vary with the internal diameter decreasing along the shaft from the first end to the second end. When the first or second end comprises a female connector, then the internal diameter is measured immediately adjacent the cavity housing the female connector.

The minimum shaft wall thickness is typically at least 12 mm or at least 15 mm or at least 18 mm or at least 20 mm or at least 22 mm or at least 25 mm or at least 27 mm or at least 30 mm or at least 35 mm or at least 40 mm. The minimum shaft wall thickness is typically located towards the second end of the degasser shaft and typically corresponds to the minimum external diameter of the degasser shaft. For long shafts the minimum wall thickness of typically in the range of 20 mm to 45 mm or 22 mm to 42 mm or 25 mm to 40 mm. For medium shafts, minimum wall thickness of typically in the range of 14 mm to 25 mm or 16 mm to 22 mm or 17 mm to 21 mm. For short shafts, minimum wall thickness of typically in the range of 10 mm to 17 mm or 11 mm to 16 mm or 12 mm to 15 mm.

The maximum shaft wall thickness is typically no more than 80 mm or no more than 70 mm or no more than 60 mm. The maximum shaft wall thickness is typically located towards the first end of the degasser shaft and typically corresponds one or about where the melt line of the degasser shaft is positioned (e.g. ±50 mm). The melt line is typically located between 40 mm and 500 mm from the first end of the degasser shaft and within the 1st portion depending upon the total length of the shaft and the degasser system configuration. When a female connection is used to couple the degasser shaft to the motor, the melt line is preferably located below the female connection and preferably at least 20 mm or at least 40 mm below the female connection. The melt line and female connection are both regions of potential weakness due to corrosive stress concentration. As such, these regions are preferably separated.

In some embodiments, the wall thickness at the second end of the shaft is in the range of 12 to 60 mm or 14 to 50 mm or 16 to 40 mm; and the wall thickness at the first end or the melt line is in the range of 20 to 80 mm or 22 to 70 mm or 24 to 60 mm. In some embodiments, the ratio of the minimum shaft thickness (second end) to the maximum shaft thickness (first end or melt line) is in the range of least 0.3 and less than 1.0 or in the range of 0.4 to less than 0.95 or in the range of at least 0.5 to less than 0.90 or in the range of at least 0.6 to less 0.85. In some embodiments, the maximum wall thickness (Wallₘₐₓ) of the degasser shaft is located at or proximal (e.g. within 10 mm) to where the degasser shaft has the maximum external diameter and the minimum wall thickness (Wallₘᵢₙ) of the degasser shaft is located at or proximal (e.g. within 10 mm) the second end and wherein the ratio of Wallₘᵢₙ/Wallₘₐₓ is in the range of 0.75 to 1.0 or in the range of 0.80 to 0.95. By maintaining a relatively similar wall thickness, whilst increasing the diameter of the shaft, weight can be removed from the shaft, whilst the oxidative corrosive resistance of the ceramic composite enables relatively thinner wall thickness to provide sufficient oxidative corrosive resistance.

In some embodiments, Dₘₐₓ/Dₘᵢₙ is greater than 1.3 and Wallₘᵢₙ/Wallₘₐₓ is in the range of 0.80 to 1.0.

In some embodiments, the wall thickness of the shaft changes along the shaft's length. In some embodiments, the wall thickness is greatest towards the first end and thinnest towards the second end. In some embodiments, the wall thickness is greatest at or around the melt-line and thinnest towards the second end. The difference in thickness between the thinnest and the thickest walls is typically between 10% and 300% or between 20% and 200% or between 30% and 100% of the thinnest wall. By changing the thickness of the shaft along its length, greater oxidative corrosive and stress resistance (e.g. thicker walls) as well as vibrations minimization can be applied where needed, without unnecessarily increasing the weight of the shaft.

A preferred embodiment the degasser shaft comprises:
a. a total length of between 250 and 2200 mm;
b. a first constant segment comprising a length in the range of 0 to 600 mm (or 10 mm to 500 mm);
c. a tapered segment, abutting the optional further constant segment, comprising a diameter which decreases as the tapered segment extends towards the second end, said tapered segment comprising an axial length in the range of 100 to 2200 mm;
d. an optional second constant segment
e. a first shaft end diameter in the range of 60 to 180 mm;
f. a second shaft end diameter in the range of 45 to 140 mm; and
g. a passage diameter in the range of 10 to 60 mm.

The degasser shaft preferably comprises a ceramic composite.

In another preferred embodiment a short degasser shaft comprises:
a. a total length of between 250 and 600 mm (or 280 to 500 mm);
b. the first constant segment comprising a length in the range of 50 to 100 mm;
c. a tapered segment abutting the first constant segment comprising a diameter which decreases as the tapered segment extends towards the second end, said tapered segment comprising an axial length in the range of 100 to 400 mm;
d. an optional second constant segment;
e. a first shaft end diameter in the range of 60 to 90 mm;
f. a second shaft end diameter in the range of 45 to 70 mm; and
g. passage diameter in the range of 10 to 25 mm.

The minimum wall thickness of the short degasser shaft may be in the range of 10 mm to 24 mm or 12 mm to 22 mm or 14 mm to 20 mm. The maximum wall thickness may be in the range of 18 mm to 32 mm or 20 mm to 30 mm or 22 mm to 28 mm.

In a preferred embodiment a medium degasser shaft comprises:
a. a total length of between 500 and 1500 mm;
b. an optional first constant segment extending from or proximal to the first end comprising a length in the range of 0 to 400 mm;
c. a tapered segment abutting the optional first constant segment, when present, comprising a diameter which decreases as the tapered segment extends towards the second end, said tapered segment comprising an axial length in the range of 500 to 1500 mm;
d. an optional second constant segment contiguously extending from the tapered segment to the second end;
e. a first shaft end diameter in the range of 70 to 150 mm (or 80 to 140 mm);
f. a second shaft end diameter in the range of 50 to 130 mm (or 60 to 120 mm); and
g. a passage diameter in the range of 10 to 50 mm (or 15 to 40 mm).

The minimum wall thickness of the medium degasser shaft may be in the range of 20 mm to 34 mm or 22 mm to 32 mm or 24 mm to 30 mm. The maximum wall thickness may be in the range of 27 mm to 42 mm or 29 mm to 40 mm or 31 mm to 38 mm.

In a preferred embodiment a long degasser shaft comprises:
a. a total length of between 1500 and 2200 mm;
b. the first constant segment extending from or proximal to the first end comprising a length in the range of 100 to 600 mm (or 120 to 500 mm);
c. a first tapered segment contiguously abutting the first constant segment comprising a diameter which decreases as the tapered segment extends towards the second end, said tapered segment comprising an axial length in the range of 400 to 2200 mm;
d. an optional second constant segment contiguously extending from the tapered segment to the second end;
e. an optional second tapered segment contiguously abutting an end of the first constant segment and contiguously extending to the first end and comprising a length of 0 to 600 mm (or 10 to 500 mm or 120 to 350 mm);
f. a first shaft end diameter in the range of 80 mm to 200 mm (or 90 to 180 mm);
g. a second shaft end diameter in the range of 80 to 140 mm; and
h. a passage diameter in the range of 10 to 60 mm.

The minimum wall thickness of the long degasser shaft may be in the range of 10 mm to 24 mm or 12 mm to 22 mm or 14 mm to 20 mm. The maximum wall thickness may be in the range of 18 mm to 32 mm or 20 mm to 30 mm or 22 mm to 28 mm.

The internal diameter of the degasser shaft defining the passage may be at least 12 mm or at least 14 mm or at least 16 mm or at least 18 mm or at least 20 mm or at least 22 mm or at least 24 mm or at least 26 mm. The maximum internal diameter of the passage is typically no more than 70 mm or no more than 65 mm or no more than 60 mm or no more than 55 mm or no more than 50 mm. The degasser shaft preferably comprises or consists of a ceramic composite. In some embodiments, the degasser shaft doesn't not comprise any components or parts made prominently of graphite (e.g. at least 50 wt % or at least 80 wt % or at least 98 wt %). Graphite components, whilst possessing good mechanical properties, such as rigidity have poor oxidative corrosion resistance.

The degasser shafts of the present invention are compatible with a range of degassing systems, including the Foseco FDU degasser, STAS degasser, Novelis ALPUR degasser and Hertwich degasser systems. Advantageous, the shafts of the present invention not only provide the mechanical durable under varying rotational speeds, but the degasser shaft have superior anti-oxidative corrosive resistance to ensure a longer working life.

### Ceramic Composite

The ceramic composite may comprise a composite comprising refractory particles and graphite flakes within an inorganic (e.g. glass and/or mullite) or organic binder matrix (e.g. ceramic carbon composite). The refractory particles may comprise any suitable refractory materials with suitable mechanical strength; oxidative resistance; erosion resistance; thermal shock and impact resistance. Suitable particles may include carbides, including silicon carbide; nitrides, including silicon nitride; alumina, zirconia and aluminosilicates. The refractory particles are preferably crystalline or partially crystalline. Graphite flakes function is mostly to enhance machinability during manufacturing whereas providing strength to the material. In some embodiments, the ceramic composite may comprise inorganic fibres which may enhance the flexural strength of the composite.

The ceramic composite may be formed from clay or resin bonded ceramic composite precursor material. Ceramic composites formed from a clay bonded composite precursor may comprise refractory particles embedded in an aluminosilicate matrix. The aluminosilicate matrix may be a glassy and/or crystalline (e.g. mullite). An aluminosilicate matrix is defined as a matrix comprises at least 60 wt % or at least 70 wt % or at least 80 wt % of alumina+silica. Ceramic composites formed from a resin bonded ceramic composite precursor may comprise refractory particles embedded in a carbon matrix.

Examples of suitable ceramic composites are disclosed in WO2022013523, which is disclosed therein by reference. The ceramic composites generally have superior oxidative corrosion resistance compared to carbon composites or graphite-based shafts. However, ceramic composites are not directly substitutable for graphite and carbon composite materials due to their higher density and reduced mechanical properties including lower stiffness and flexural strength.

The ceramics composites may be coated or impregnated using compositions and methods known to those in the art.

### Composite Properties

The ceramic composite typically comprises a density of at least 1.90 g/cc or at least 2.0 g/cc or at least 2.1 g/cc or at least 2.2 g/cc. The upper limit is generally limited by the refractory materials used in the composite, but is generally less than 2.5 g/cc. Due to the lower density of carbon, ceramic composites comprise a carbon matrix generally have a lower density than clay/glass bonded ceramic composites.

The stiffness of a material may be determined through its Young's modulus. The Young's modulus of the composite materials are typically significantly lower than graphite based materials, which comprise a Young's modulus in the order of 10 to 20 GPa. In contrast the Young's modulus of ceramic composites can vary upon ingredients addition and is generally between 0.5 (or 1.0 or 2.0) and 20 GPa with many ceramic compositions comprising a Young's modulus less than 10 GPa or less than 8 GPa or less than 6 GPa. In one embodiment, in the Young's modulus of the ceramic composite materials is in the range of 0.5 GPa to 10 GPa.

The tensile bending strength or flexural strength is an indication of a material ability to withstand cycling bending stress prior to mechanical failure, i.e. an indicator of the flexural fatigue strength. In one embodiment, the flexural strength the of the ceramic composite material is in the range of 5 MPa to 30 MPa. The flexural strength of the ceramic composites may be at least 8 MPa or at least 10 MPa or at least 12 MPa or at least 14 MPa with an upper limit of no more than 30 MPa or no more than 25 MPa or no more than 20 MPa. The flexural strength of ceramics composites, and more significantly the flexural fatigue strength, may be increased to the upper end of the range through controlling particle size and porosity of the composite as known to those skilled in the art. The flexural strength of graphite materials is typically greater than that of ceramic composites, in the range of 18 MPa to 36 MPa whereas its flexural fatigue strength for a given number of cycles, and under a given stress ratio, follows a similar trend.

### Operation

The natural frequency of the shaft is an important design consideration as when the rotational speed of the shaft approaches the natural frequency of the shaft, there is a significant increase in the amplitude of vibrations of the shaft. This increase in vibration places increased stresses upon the shaft, which may result in premature mechanical failure of the shaft. Therefore, it is desirable for the natural frequency of the shaft to be above the target operational rotational speed, preferably by at least 30%.

There are a number of factors which may influence the natural frequency of the degasser shaft, including:
the length of the shaft (shorter shaft=higher natural frequency)
the weight of the shaft (an increase in weight=lower natural frequency)
the stiffness of the shaft (increase in stiffness=higher natural frequency)

The stiffness of the shaft may be influenced by the design of the shaft including the moment of inertia of the shaft cross section, with wider diameter shaft being stiffer. However, an increase in shaft weight may result in a decrease in the natural frequency. The selection of materials may also significantly impact the natural frequency of the shaft, with stiffer materials resulting in a shaft with higher natural frequency. The applicant has found that through a combination of design modification and material selection, not only can longer shafts (e.g. greater than 1.5 m) be produced with a high enough natural frequency to enable the shaft to operate the a target rotational speed for high density (>2 g/cc) low stiffness materials (<10 GPa), which is sufficiently below the natural frequency such to avoid any amplification of vibrations. Further, this objective may be met with ceramic composite materials which enable the oxidative corrosion and erosion resistance of the shaft to be enhanced, particularly in comparison to graphite-based shafts.

The natural frequency of long (i.e. length greater than 1500 mm) degasser shafts may be in the range of 150 to 500 rpm or 200 to 480 rpm or 250 to 450 rpm.

In a second aspect of the present invention, there is provided a process for degassing a molten metal melt comprising submerging a degassing apparatus into the molten metal melt, said degassing apparatus comprising a degassing shaft according to the first aspect of the present invention and wherein the rotational speed of the degassing shaft is below the natural frequency of the shaft.

The rotational speed of the degassing shaft is preferably at least 20 rpm or at least 40 rpm or at least 50 rpm below the natural frequency of the shaft.

In one embodiment, the shaft length is in the range of 1.5 to 2.2 metres or at least 1.8 to 2.2 metres of 1.9 to 2.1 metres and the natural frequency of the shaft is greater than 300 rpm or 350 rpm or 400 rpm.

Reference to diameter is inclusive of effective diameter when the cross-sectional area of the shaft is not circular. The effective diameter is deemed to be the diameter of a circle with the same cross-sectional area as the non-circular shape.

For the purposes of the present invention, a tapered segment is inclusive of frustoconical segments and polygonal prisms comprising a decreasing cross-sectional area from one end to the other. For example, a segment of a pyramid would be considered a tapered segment. However, in some embodiments, the tapered segment does not comprise any planar surfaces.

Flexural strength and transverse bending strength are used interchangeably throughout the specification.

For the avoidance of doubt, it should be noted that in the present specification the term “comprise” in relation to a composition is taken to have the meaning of include, contain, or embrace, and to permit other ingredients to be present. The terms “comprises” and “comprising” are to be understood in like manner. It should also be noted that no claim is made to any composition in which the sum of the components exceeds 100%.

Further it should be understood that usage in compositions of the names of oxides [e.g. alumina, and silica] does not imply that these materials are in a specific stoichiometric form, but refers to the composition of the composite expressing the relevant elements as oxides. It would be understood at the elements may also be present in non-oxides forms.

For the purposes of the present invention, the length of the tapered segment is taken to be the axial length.

For the purposes of the present invention, a degasser shaft is separate and distinct from a degasser shaft sleeve.

The term portion is used to denote one or more segments.

Unless otherwise indicated or implicated, reference to a diameter is reference to an external diameter.

The determination of the minimum and maximum wall thickness of the shaft excludes any measurements around the connection point to the motor or rotor or any flanged region immediately adjacent the rotor.

### BRIEF DESCRIPTION OF THE FIGURES

FIG. 1 is a schematic diagram of a degasser shaft design with connectable rotor according to the present invention.

FIG. 2 is a cross-sectional view of the degasser shaft design of FIG. 1 without the rotor and showing an exploded view of a section of the female connection.

FIG. 3 is a schematic diagram of a degasser shaft design of Comparative Example 1 (CE-1).

FIG. 4 is a schematic diagram of a degasser shaft design of Example 2.

FIG. 5 is a schematic diagram of degasser shaft design of Examples 5 & 6.

FIG. 6 is a schematic diagram of degasser shaft design of Example 3.

FIG. 7 is a photograph of the degasser shaft design of FIG. 3 which has mechanically failed.

FIG. 8 is a design drawing of Comparative Example 5 (CE-5)

FIG. 9 is a design drawing of Comparative Example 6 (CE-6)

FIG. 10 is a design drawing of Example 7.

### DETAILS DESCRIPTION OF A PREFERRED EMBODIMENT OF THE INVENTION

The invention is exemplified by reference to a frustoconical tapered segment and an optional cylindrical segment, but the invention is not limited thereto.

The degasser shafts of the present invention are made using conventional techniques with the raw materials mixed, dried and filled into moulds before being pressed and sintered or fired at high temperatures (e.g. >1000 °C) for sufficient time to sinter or otherwise harden the binder and the ceramic composite together. The degasser shaft preferably comprises one or both of one material and one-piece construction.

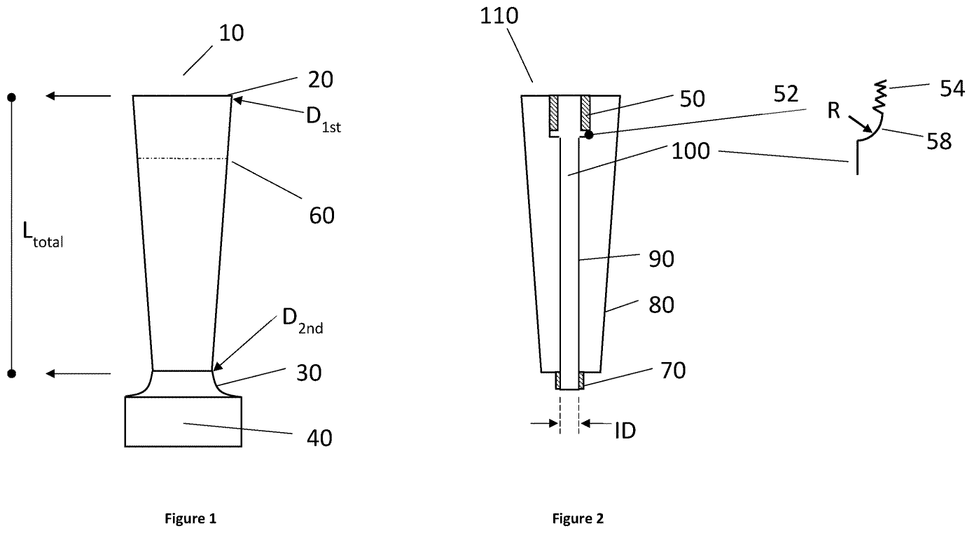

With reference to FIGS. 1 & 2, there is illustrated a schematic diagram of degasser shaft 10 and a cross-section thereof 110. The shaft has a first end 20 which is connectable to a motor. The connection is a female connection 50, which may comprise a spiral threaded section 50 adapted to receive a complementary male connection (not shown) of the motor or apparatus connected to the motor. To avoid a concentration of stress in the female connector during operation, the connector comprises a rounded or arced transition segment 58 between the spiral threaded section and the passage 100. The degasser shaft also has a second end 30 which may comprise a rotor 40 in a one piece construction in which the rotor is seamlessly connected to the shaft. Alternatively, as illustrated in FIG. 2, the second end of the degasser shaft may comprise a male spiral threaded section forming a connector 70 which is connectable to the complementary spiral threaded female (not shown) connector of the rotor.

The first end 20 comprises the maximum diameter of the shaft (D₁ₛₜ). The second end 30 comprises the minimum diameter of the shaft (D_{2nd}).

The degassing shaft has an external diameter 80 and an internal diameter 90, which defines a passage 100 which extends from the first end 20 to the second end 30. The external diameter of the degasser shaft defines a frustum of a right circular cone, which extends the total length (Lₜₒₜₐₗ) of the degasser shaft (i.e. the length of the male connector is not included in the total length of the degasser shaft).

The internal diameter of the degasser tube may be defined by cylindrical portions and/or frustoconical portions. To increase the stiffness of the degasser shaft the external diameter may be increased. To avoid the associated increase in weight of the shaft, the internal diameter may also be increased in at least some portions of the shaft. The passage may be formed using one or more cylindrical or tapered (i.e. frustoconical) mandrels in cooperation with a mould defining the external diameter of the shaft. In some embodiments, the passage has an increasing cross-sectional area from the first end of the point of the maximum diameter of the degasser shaft (e.g. the melt line). This enables, the wall thickness differential between the minimum wall thickness to the maximum wall thickness to be minimised to assist in removing weight from the degasser shaft. In some embodiments, the wall thickness is thickest at the point of the maximum diameter of the degasser shaft.

In operation the degasser shaft is positioned within a vessel containing molten metal. Depending upon the setup of the degasser apparatus, the degasser shaft will be immersed in the molten metal up to what is termed the “melt line”, the level of the shaft which comprises the interface between the molten level and the gaseous atmosphere above. The melt line 60 of the shaft is exposed to the most oxidative corrosive environment and, as such, it prone to mechanical failure at this point due to weakening of the degasser shaft, due to oxidative corrosion. To mitigate the risk of mechanical failure of the degasser shaft around the melt line, the wall thickness of the shaft may be larger in this section of the degasser shaft compared to other sections of the degasser shaft.

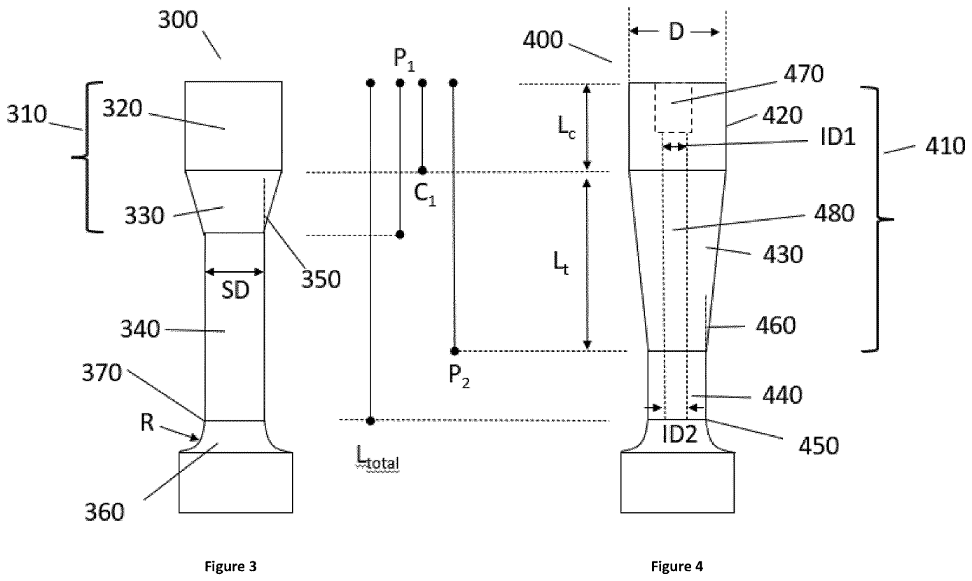

FIGS. 3 & 4 illustrates variations of the frustoconical shaped degasser shaft of FIGS. 1 & 2, with the first portion 310, 410 comprising a cylindrical shaped portion 320, 420 and a frustoconical shaped portion 330, 430. The frustoconical portion abuts a cylindrical section 340, 440 which extends to the second end of the degasser 450.

As illustrated in FIG. 4, the wall thickness of the shaft is at a maximum at the cylindrical portion 420 where the melt-line is located and it at a minimum at the cylindrical portion 440 at the second end of the degasser shaft 450. This configuration provides the greatest oxidative corrosion resistance at the location where oxidative corrosion is greatest, at the interface between the gaseous atmosphere and the molten metal. In other embodiments (e.g. some shorter shafts), the melt-line may be located in first portion in the bottom half or bottom third of the shaft. Preferably, the melt-line is positioned at an external diameter of the shaft greater than the minimum shaft external diameter and preferably the melt line is positioned at a shaft wall thickness greater than the minimum shaft wall thickness.

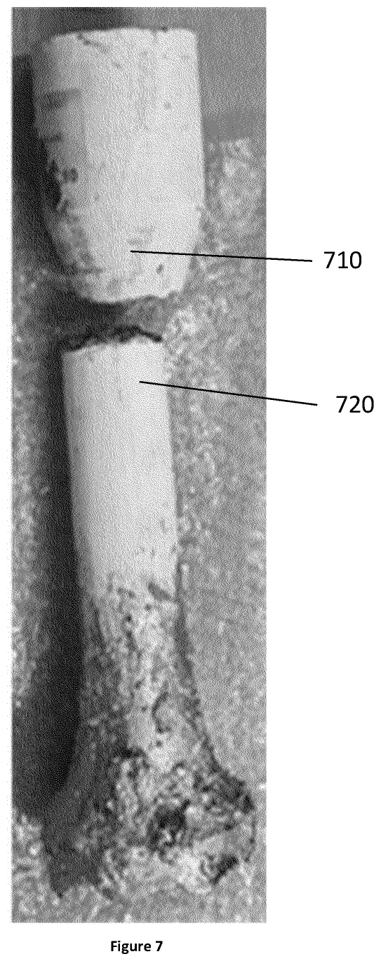

The degasser shaft design 300 of FIG. 3 is a comparative example as the first portion 310 does not extend the required portion of the total length (Lₜₒₜₐₗ) of the degasser shaft. The consequences of this are that (i) the stiffness of the degasser shaft is lower due to the relatively smaller external diameter of the degasser shaft (SD) in the lower cylindrical section 340; and (ii) the acuter joining angle 350 between the frustoconical portion and the cylindrical portion 340 relative to the corresponding joining angle 460 in FIG. 4. These differences are illustrated through the first portion in the degasser shaft of FIG. 4 being longer than the degasser shaft in FIG. 3 (P₂>P₁) and the frustoconical portion in FIG. 4 being longer than in FIG. 3 (P₂−C₁>P₁−C₁). The combination of these two design features may, depending upon the operating conditions, significantly reduce the concentration of stresses on sections of the degasses shaft and thereby reduce the frequency of mechanical failure in the shafts. FIG. 7 illustrates the location of mechanical failure of a short degasser shaft category design similar to that of FIG. 3, with the failure point being at and around the intersection of the frustoconical 710 and cylindrical portion 720.

The radius R defining the tapered shoulder of the rotor 360, will dictate the deemed end of the second end of the shaft 370, when the rotor is seamlessly connected to the degasser shaft 300.

The design configuration of FIG. 4 is able to maintain a similar, if not better, performance to the designs of FIGS. 1 & 2, as the melt line is positioned within the cylindrical portion 420 for medium and longer shafts, thereby maintaining the melt line at the maximum diameter of the degasser shaft. Whilst the length (L_{c}) of the cylindrical portion 420 is the same as the cylindrical portion in FIG. 3, 320, the length (Lₜ) of the tapered portion 430 is significantly longer than the tapered portion in FIG. 3, 330, thereby contributing to a higher stiffness.

Further a relatively small cylindrical section 440 adjacent to the second end of the degasser shaft 450 has been shown not to significantly impede performance, which may be at least partially offset by the lower weight of this section compared to the frustoconical counterpart.

Additionally, the internal diameter of the passage at the first end ID1 through to the internal diameter of the second end ID2 may be widened to reduce the weight of the degasser shaft. This is particularly advantageous in longer degasser shafts where total weight and weight distribution of the degasser shaft can affect the natural frequency of the degasser shaft in operation. The internal diameter of the passage at the first end ID1 may be measured immediately below any female connection cavity 470 which may exist. The passage 480 may be cylindrical, in which case the wall thickness of the degasser shaft is at a maximum at the melt line for medium and longer shafts, which is positioned within the cylindrical portion 420, thereby adding the oxidative resistance to the shaft at the point which requires most protection. A shaft may also have a tapered passage to reduce total shaft weight, if required.

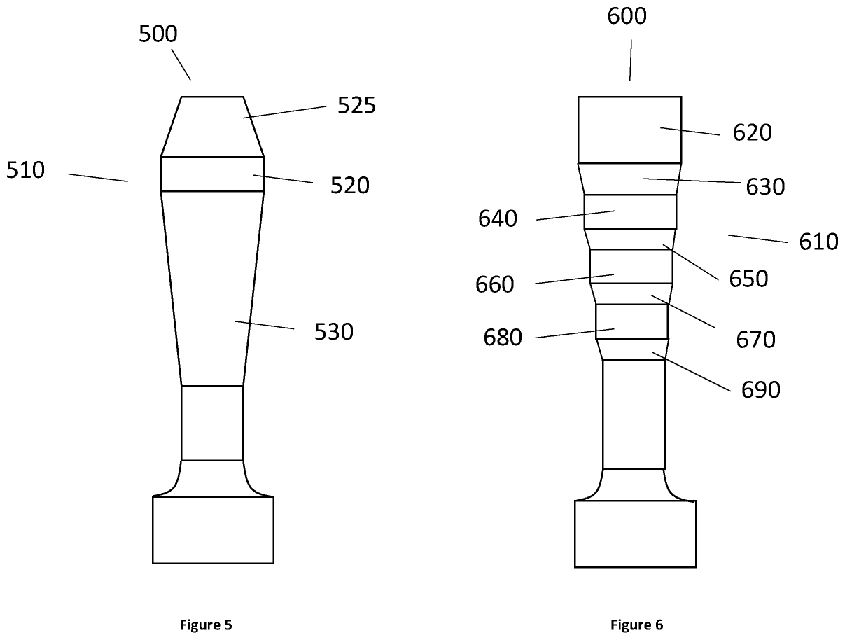

Further variations of designs within the scope of the present invention are provided in FIGS. 5 & 6. The degasser shaft design of FIG. 5 differs from FIG. 4 in that the cylindrical portion 420 is partially substituted by a frustoconical portion 525 tapering from the cylindrical portion to the first end of the degasser shaft. This results in the cylindrical section 520 being offset from the first end. This configuration may enable the first end of the degasser shaft to fit into existing degasser apparatus which may include safety guards and housing features as well as reducing the overall weight of the shaft. Further, the maximum external diameter of the shaft, for medium and long shafts, may be maintained around the melt line at, or around, the cylindrical portion. Alternatively, the melt-line may be positioned at the upper portion of the frustoconical portion 530. It would be understood that degasser apparatus may be set up to accept conventional shafts which may having smaller external diameters.

FIG. 6 illustrates a shaft 600 with a design variation which still comprises a first portion 610 comprising a first cylindrical portion at the top of the shaft 620. The first portion further comprises a frustoconical shaped portion which includes a cascading or step-down portion which includes a series of cylindrical portions of decreasing diameters 640, 660, 680 separating a series of frustoconical sections of decreasing diameters 630, 650, 670, 690.

The specific design features of the degasser shaft will depend upon the operating environment that the degasser shafts will be exposed to, as well as the properties of the corrosive and erosion resistant ceramic composites requires to prolong the operating life of the degasser shaft. Short shafts (e.g. less than 600 mm in length) generally operate at high rotations speeds and the shaft design focus is upon reduce stress concentrations due to the deflection of the shaft, particularly shafts with a relatively low stiffness (i.e. relatively low Young's modulus). Increasing the shaft diameter and minimise stress concentration points are often a design focus. For longer shafts the avoidance of excessive vibrations resulting in heightened stress levels of the shaft is often a focus with shaft weight and weight distribution a further design priority.

The scope of the present invention is not limited to the specific embodiments illustrated herein. The skilled artisan would be able to readily use the teachings herein to create numerous modifications and variations falling within the scope of this disclosure.

### Examples

A number of shaft designs was assessed under simulated conditions. It is noted that, for the purposes of the experiment, the end of the shaft for the short rotors were taken to be the maximum diameter of the rotor rather than the minimum diameter of the shaft proximal the rotor. Given the weight of this additional portion was similar, the results are still considered valid for comparative purposes.

### Short Degasser Shafts

The Short degasser shaft designs indicated in Table 2 are capable of being operated at between 700 to 1000 rpm and were compared in relation to their maximum stress levels and maximum displacement when placed under a 25N loading.

The shafts were made from a ceramic carbon composite at Molten Metal Systems GmbH comprising approximately 65 wt % refractory particles (about 40 wt % SiC with the majority of the remainder comprising alumina and aluminosilicate particles) and approximately 35 wt % of a carbon matrix and graphite flakes and having a density of 2.2 g/cc, a Young's modulus of 3 GPa and a flexural strength of 11 Mpa.

The geometry of the different degasser shaft designs Is provided in Table 2, with reference to FIGS. 3&4.

TABLE 2
(measurements in mm)

| | CE-1 | 1 | 2 | 3 | CE-2 |
|---|---|---|---|---|---|
| First end diameter (D1) | 79 | 72 | 68 | 70 | 63.5 |
| First end cylinder length | 75 | 75 | 75 | 75 | 105 |
| Second end diameter (D2) | 51 | 50 | 47 | 47 | 54.5 |
| Ratio of D1 to D2 | 1.5 | 1.4 | 1.4 | 1.5 | 1.2 |
| Wallₘᵢₙ | 18.7 | 16.3 | 13.8 | 13.8 | 17.3 |
| Wallₘₐₓ | 32 | 26 | 24 | 25 | 21 |
| Dₘₐₓ/Wallₘₐₓ | 2.5 | 2.8 | 2.8 | 2.8 | 3.0 |
| Dₘᵢₙ/Wallₘᵢₙ | 2.73 | 3.07 | 3.41 | 3.41 | 3.15 |
| Second end flange radius (R) | 150 | 100 | 50 | 50 | 50 |
| First end internal diameter (ID1) | 15 | 20 | 20.5 | 20.5 | 21 |
| Second end internal diameter (ID2) | 13.3 | 17.4 | 19.5 | 19.5 | 20 |
| 1^{st} portion length | 115 | 191 | 230 | 204 | 120 |
| Shaft-Total length (Lₜₒₜₐₗ) | 253 | 266 | 292 | 292 | 292 |
| % 1^{st} portion of Lₜₒₜₐₗ | 45 | 72 | 79 | 70 | 41 |
| % frust. Portion of 1^{st} portion | 35 | 61 | 67 | 63⁺ | 13 |
| Weight | 2.5 | 2.5 | 2.0 | 2.0 | 2.0 |
| Incident angle | 19.3 | 3.2 | 3.9 | 9.5 | 16.7 |

⁺the frustoconical portion includes the cylindrical segments with smaller external diameters than the first cylindrical segment, but larger external diameter segments than the second cylindrical segment.

TABLE 3

| | Max | Max |
|---|---|---|
| | Stress | Displ |
| | (MPa) | (mm) |
| CE-1 | 0.70 | 0.34 |
| 1 | 0.28 | 0.23 |
| 2 | 0.35 | 0.32 |
| 3 | 0.35 | 0.32 |
| CE-2 | 0.45 | 0.35 |

As indicated in Tables 2 & 3, designs 1 to 3 possessed the lowest maximum stress and lowest maximum displacements when subjected to a 25N loading. The comparative examples possessed both higher maximum stress and displacement levels and hence are more prone to mechanical failure. Despite these superior mechanical properties, the corrosion resistance of graphite is significantly lower than ceramic composite materials. While CE-1 and CE-2 possessed a relatively high 1^{st} portion, the frustoconical component of this was relatively small resulting in relatively high incidental angles which may have contributed to the higher maximum stress levels obtained with these designs.

### Long Degasser Shafts

The ceramic composite used was similar in composition and properties to that of the short degasser shaft, although the Young's modulus was 3 GPa. The properties of the ceramic composites are provided in Table 4. The natural frequency of the degasser shaft was determined when the shaft was attached to a rotor. The weight of the rotor was 5.8 kg, except for sample CE-4 where the rotor weighed 4.5 kg. This was due to this rotor being made of graphite rather than the ceramic composite that the other rotors were made of. Frequency response analysis of the shafts and rotors, to determine the natural frequency, was determined based upon a 1 kg lateral excitation at the base of the rotor, with 0% dampening applied. The dampening, usually created by a liquid, impacts the amplitude of the vibration, but not the value of the natural frequency. For 0% dampening, shafts are being rotated in air.

As illustrated in Table 4, the conventional cylindrical shaft (CE-3) made from a ceramic composite had a low natural frequency which was not suited to operation at or above 220 rpm without being prone to amplified vibrations. In contrast, the natural frequency of a similarly dimensioned degasser shaft made from graphite was 550 rpm. The increase in the natural frequency may be attributable to the properties of graphite which is stiffer (e.g. high Young's modulus) and lighter (e.g. lower density).

The tapered degasser shaft (4) is able to reduce the weight of the degasser shaft and, despite the reduced diameter of the shaft at the second end, the natural frequency of the degasser shaft increases to 260 rpm. Further increases in natural frequency of the degasser shaft is achieves in Examples 5 & 6 through increasing the diameter of the degasser shaft at the first end, despite this resulting in an increase in the weight of the degasser shaft compared to Example 3. Examples 3 to 5 all had a lower degasser shaft weight compared to the ceramic composite degasser shaft of Comparative example 3 (CE-3). The wider diameters of Examples 3 to 5 were combined with a lower minimum wall thickness to achieve this lower degasser shaft weight.

TABLE 4
(measurements in mm)

| | CE-3 | 4 | 5 | 6 | CE-4 |
|---|---|---|---|---|---|
| Lₜₒₜₐₗ | 1945 | 1945 | 1945 | 1945 | 1945 |
| Dₘₐₓ | 125 | 125 | 150 | 152.5 | 125 |
| Dₘᵢₙ | 125 | 100 | 90 | 95 | 125 |
| Ratio Dₘₐₓ to Dₘᵢₙ | 1 | 1.25 | 1.67 | 1.6 | 1 |
| ID(_{second end}) | 26 | 25 | 25 | 40 | 26 |
| Wallₘᵢₙ | 49.5 | 37.5 | 32.5 | 27.5 | 38.3 |
| Wallₘₐₓ | 49.5 | 50 | 62.5 | 56.3 | 49.5 |
| Dₘₐₓ − Dₘᵢₙ | 0 | 25 | 60 | 57.5 | 0 |
| Dₘᵢₙ/Wallₘᵢₙ | 2.53 | 2.67 | 2.77 | 3.45 | 3.25 |
| Dₘₐₓ/Wallₘₐₓ | 2.53 | 2.5 | 2.4 | 2.7 | 2.53 |
| 1^{st} portion length | 0 | 1945 | 1575 | 1175 | 0 |
| OD first end | 125 | 125 | 125 | 125 | 125 |
| Cylindrical start from first end | — | — | 275 | 275 | — |
| Cylindrical finish from first end | — | — | 415 | 415 | — |
| Cylindrical portion (mm) | — | 0 | 140 | 140 | — |
| % 1^{st} portion of Lₜₒₜₐₗ | — | 100% | 81% | 60% | — |
| % frust. Portion of 1^{st} portion | — | 100% | 91% | 88% | — |
| Density (g/cc) | 2.2 | 2.2 | 2.2 | 2.2 | 1.7 |
| Flexural strength (MPa) | 11 | 11 | 11 | 11 | 15.2 |
| Young's modulus (GPa) | 3 | 3 | 3 | 3 | 13 |
| Shaft weight (Kg) | 48.3 | 38.5 | 44.6 | 45.0 | 37.4 |
| Natural Frequency (rpm) | 220 | 260 | 340 | 360 | 550 |
| Corrosive resistance* | OOO | OOO | OOO | OOO | O |

*OOO > OO > O in terms of corrosion resistance

### Service Life

While the service life of graphite shafts is typically dictated by corrosion caused mechanical failure, the ceramic composite shaft service life is dictated by mechanical failure due to fatigue.

Fatigue testing was undertaken to establish how the designs of the present invention, through increasing rigidity, targeted weight distribution, and avoiding stress concentrations are able to increase the service life of ceramic composite shafts.

### Fatigue Testing Apparatus

a. Setup: The fatigue testing machine comprises a fixed rig with a shaft assembly. The shaft is fixed at the top coupling, connected to the fixed rig, and has a bottom coupling that moves horizontally, inducing a deflection simulating in-application conditions.
b. Load: A set deflection is applied to the shaft through the horizontal movement of the bottom coupling. The shaft does not rotate, but is cycled through horizontal deflections.

### Testing Procedure:

a. Specimen Preparation: Fabricate six test specimens for each design variation.
b. Offset Determination: Through use of a frequency response chart and confirmed empirically by a laser measurement device for a cyclic speed of 600-800 cycles per minute (cpm).
c. Cyclic Loading Profile: The deflection is applied to the shaft at a given cyclic speed. The rig cyclic speed only impacts the test duration, as the offset is already fixed.
d. Test Duration: The duration of the fatigue test is not predetermined, and the tests continue until shafts have failed. After 1,000,000 (1M) cycles at a deviation of 1.8 mm, the shafts were then exposed to an increased deviation of 3.0 mm to accelerate shaft failure.

### Testing Execution:

a. Cyclic Loading: The fatigue testing is initiated, subjecting the specimens to cyclic loading at specified CPM and specified deflection.
b. Data Collection: The proximity sensor registers when a shaft breaks, indicating failure, and records the number of cycles completed by each specimen until failure.

### Data Analysis:

a. Fatigue Life Assessment: The number of cycles endured by each specimen before failure is recorded, representing the fatigue life for each design variation.
b. Failure Criteria: Specimens with visible cracks or complete breakage are considered failed.
c. Statistical Analysis: Amount of cycles endured and the percentage of shafts that failed with each design variation is calculated are put in relation to assess the relative resistance of the designs.
d. Result Interpretation: The design with the highest cycle count considered the most resilient with the ability to have a longer service life in operation, excluding other factors, such as shaft weight.

### Design Variations:

Three design variations using the ceramic composite of previous examples underwent fatigue testing.

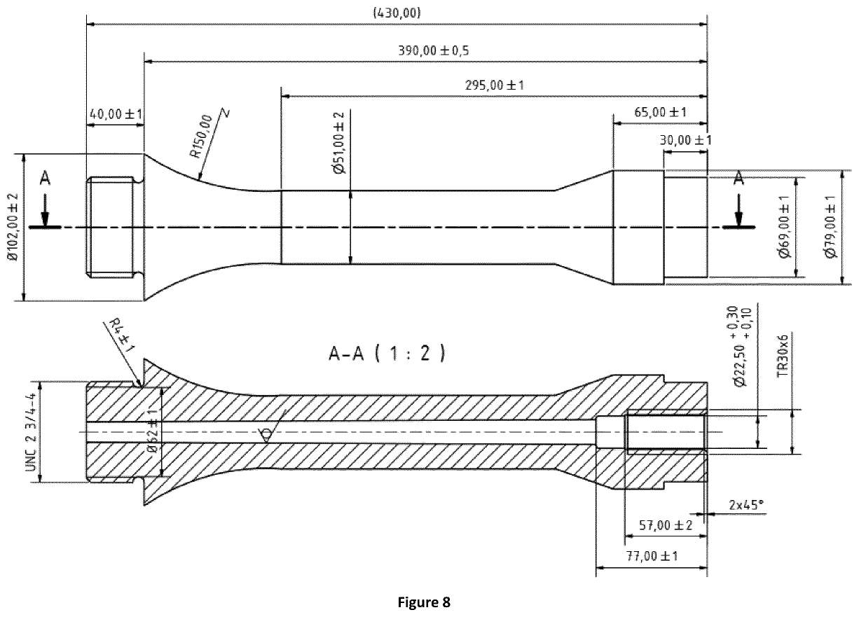

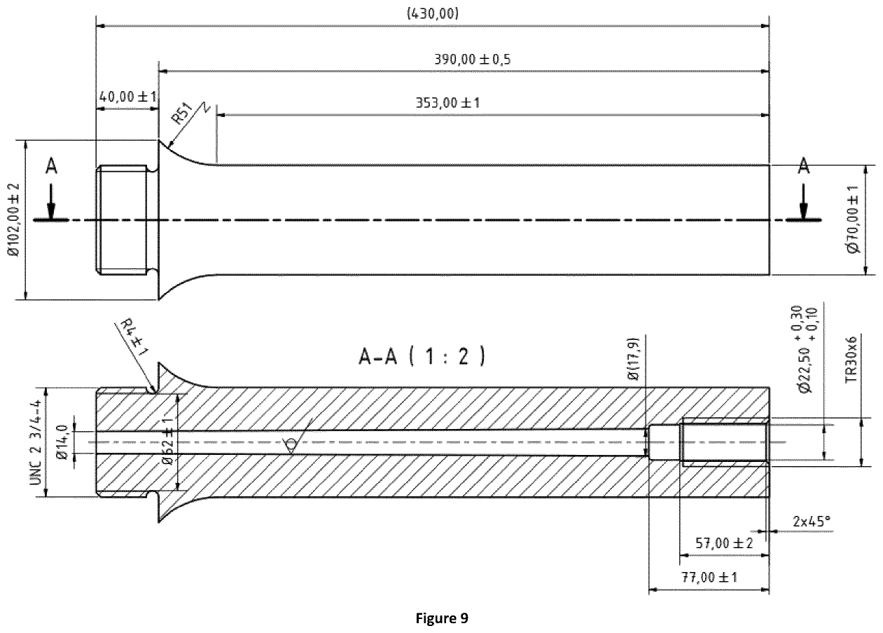

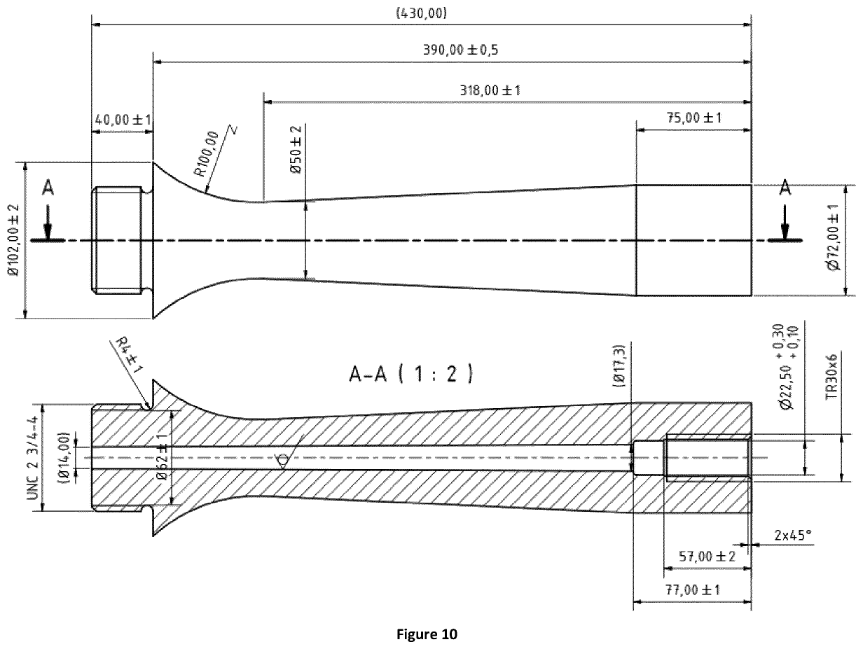

Comparative Example 5 (FIG. 8) is of a shaft comprising a first portion outside the scope of the present invention, with the frustoconical shaped portion comprising relatively acute incident angle with the adjacent cylindrical portion. Comparative Example 6 (FIG. 9) is of a shaft with a constant shaft diameter (expect for the flange portion at the second end). Example 7 (FIG. 10) is of a shaft within the scope of the present invention.

### Fatigue Testing Results

As illustrated in Table 5, Comparative Example 5 was only able to last 20 cycles with a horizontal deflection of 3.0 mm at 600 cpm. Whilst the shaft design was able to last significantly longer at a lower horizontal deflection (1.8 mm) and associated stresses, this was still less than 20% of the cyclic working life (on average) of the conventional cylindrical shaft of Comparative Example 6.

TABLE 5

| | | | | | 700 cpm |
|---|---|---|---|---|---|
| | | | | | 3.0 mm |
| | | | | | after 1M |
| | | Shaft | | | cycles at |
| Experiment | | weight | 600 cpm | | 1.8 mm |
| No. | Example | (kg) | 1.8 mm | 3.0 mm | (600 cpm) |
| 1 | CE-5 | 2.57 | | 20 | — |
| 2 | CE-5 | 2.57 | 99,026 | | — |
| 3 | CE-5 | 2.57 | 202,841 | | — |
| 4 | CE-5 | 2.57 | 269,002 | | — |
| 5 | CE-5 | 2.57 | 109,285 | | — |
| 6 | CE-6 | 3.47 | 1,000,000 | | 136,872 |
| 7 | CE-6 | 3.47 | 1,000,000 | | 121,249 |
| 8 | CE-6 | 3.47 | 1,000,000 | | 93,497 |
| 9 | 7 | 2.88 | 1,000,000 | | 72,334 |
| 10 | 7 | 2.88 | 479,039 | | |
| 11 | 7 | 2.88 | 1,000,000 | | 88,564 |

The shaft design of the present invention (Example 7) had a slightly lower working cycle life compared to Comparative Example 6 in experiments number 9 and 11, although experiment number 10 revealed a premature failure, which may be a characteristic of manufacturing variations (e.g. non-uniform material filling). However, this premature failure was still greater than twice the average cyclic life of Comparative Example 5.

The notation that experiment no. 10 is an anomaly is supported by the fact that experiment no. 10 failed about 50 mm below the threaded connection to the motor (i.e. approximately 105 mm from the first end), whereas all of experiments 6 to 8 (CE-6) and 9 and 11 (Example 7) failed at the threaded internal connection point (i.e. ≈57 mm from the first end). The different location of failure of experiment no. 10 compared to other experiments of the same design is suggestive of an inconsistency in the composite material rather than an inherent design weakness.

All of experiments 1 to 5 failed at the intersection of the tapered and cylindrical section towards the first end (≈105 mm from the first end), below the internal threaded section, suggesting that there was a concentration of stress in this region.

It is noted that Example 7 had an arced bridging connection with a radius of 2 mm. Therefore, increasing this radius to at least 5 mm would be expected to further increase the service life of the shaft as an increased radius would be expected to lower stresses in this region.

Whilst the Example 7 design (excluding experiment 10) had a comparable cyclic life to the cylindrical shaft of CE-6, the lower weight of the Example 7 design compared to CE-6 (17% reduction) has the advantage of placing a lower load on the motor and, as such, the maintenance of the motor (e.g. bearing changes) would be significantly reduced, whilst obtaining a greater than 5 times increase in shaft life before mechanical failure compared to the shaft of CE-5. The shaft designs of the present invention are able to reduce the total maintenance costs (repairs and replacement) of the degassing system throughout the shaft's lifecycle. The relatively lighter shafts are also more easily installed and have a lower energy consumption.

1. A degasser shaft for treating a molten metal with a gas, the degasser shaft comprising:
(a) a first end connectable to a drive for rotation of the degasser shaft about a longitudinal axis, the first end having a first end external diameter;
(b) a second end having a second end external diameter and either:
connectable to a rotor; or
integral with a rotor, the second end external diameter being deemed to be a minimum shaft external diameter proximal to the rotor; and
(c) a passage through which a gas travels from the first end to the second end, the passage defined by an internal diameter of the degasser shaft;
wherein the degasser shaft has a first portion located at, or towards the first end and comprising a first tapered segment decreasing in cross-sectional area towards the second end, and optionally a first constant section segment extending from the first tapered segment towards the first end, said first portion comprising between 48% and 100% of a total length of the degasser shaft; and wherein at least the first tapered segment of the degasser shaft consists of a ceramic composite material.

2. The degasser shaft according to claim 1, wherein the degasser shaft further comprises one or both of:
a first constant section segment with a cross sectional area greater than a minimum cross-sectional area of the degasser shaft and contiguously extending from the first tapered segment towards the first end; and
a second constant section segment contiguously extending from the first tapered segment towards the second end.

3. The degasser shaft according to claim 2, wherein the second constant section segment has a cross sectional area equal to the minimum cross-sectional area of the degasser shaft.

4. The degasser shaft according to claim 1, wherein the first tapered segment extends from the minimum shaft external diameter to a maximum shaft external diameter and a second tapered segment extends from the maximum shaft external diameter and decreases in cross-sectional area towards the first end.

5. The degasser shaft according to claim 4, wherein a constant section segment is disposed between the first tapered segment and the second tapered segment.

6-10. (canceled)

11. The degasser shaft according to claim 2, wherein an incident angle between a tapered segment and the second constant section segment is greater than 0° and no more than 16°.

12. The degasser shaft according to claim 11, wherein the incident angle between a tapered segment and the second constant section segment is greater than 2° and no more than 10°.

13. The degasser shaft according to claim 1, wherein the degasser shaft further comprises a melt line, said melt line being located at the maximum external diameter of the degasser shaft.

14. The degasser shaft according to claim 1, wherein a ratio of the minimum shaft wall thickness to the maximum shaft wall thickness is in the range of at least 0.3 and less than 0.90.

15. The degasser shaft according to claim 14, wherein the ratio of the minimum shaft wall thickness to the maximum shaft wall thickness is in the range of at least 0.5 and less than 0.85.

16. The degasser shaft according to claim 1, wherein the maximum external diameter of the degasser shaft (Dₘₐₓ) minus the minimum external diameter of the degasser shaft (Dₘᵢₙ) is in the range of 10 to 100 mm.

17. The degasser shaft according to claim 11, wherein Dₘₐₓ−Dₘᵢₙ is at least 30 mm.

18. (canceled)

19. The degasser shaft according to claim 1, wherein the total length of the degasser shaft is greater than 1500 mm.

20. The degasser shaft according to claim 1, in which the degasser shaft has:
a total length of between 250 and 2200 mm;
an optional first constant section segment comprising a length in the range of 0 to 600 mm;
a tapered segment abutting the first constant section segment, when present, having an external diameter which decreases as the tapered segment extends towards the second end, said tapered segment having an axial length in the range of 100 to 2200 mm;
an optional second constant section segment;
a first shaft end external diameter in the range of 60 to 180 mm;
a second shaft end external diameter in the range of 45 to 140 mm; and
a passage diameter in the range of 10 to 60 mm.
The degasser shaft according to claim 1, in which the degasser shaft has:
a total length of between 1500 and 2200 mm;
the first constant section segment comprising a length in the range of 100 to 600 mm;
a first tapered segment contiguously abutting the first constant section segment comprising an external diameter which decreases as the tapered segment extends towards the second end, said tapered segment comprising an axial length in the range of 400 to 2200 mm;
an optional second constant section segment;
an optional second tapered segment contiguously abutting an end of the first constant section segment and contiguously extending to the first end and comprising a length of 0 to 500 mm;
a first shaft end external diameter in the range of 80 to 180 mm;
a second shaft end external diameter in the range of 80 to 150 mm; and
a passage diameter in the range of 10 to 60 mm.

21. The degasser shaft claim 1, in which the degasser shaft has:
a total length of between 500 and 1500 mm;
the first constant section segment comprising a length in the range of 0 to 500 mm;
a tapered segment abutting the first constant section segment, when present, comprising an external diameter which decreases as the tapered segment extends towards the second end, said tapered segment comprising an axial length in the range of 500 to 1500 mm;
a first shaft end external diameter in the range of 70 to 150 mm;
a second shaft end external diameter in the range of 50 to 130 mm; and
a passage diameter in the range of 10 to 50 mm.

22. The degasser shaft according to claim 1, wherein the degasser shaft comprises:
a total length of between 250 and 600 mm;
a first constant section segment comprising a length in the range of 50 to 100 mm;
a tapered segment abutting the first constant section segment comprising an external diameter which decreases as the tapered segment extends towards the second end, said tapered segment comprising an axial length in the range of 100 to 400 mm;
an optional second constant section segment;
a first shaft end external diameter in the range of 60 to 90 mm;
a second shaft end external diameter in the range of 45 to 70 mm; and
a passage diameter in the range of 10 to 25 mm.

23. The degasser shaft according to claim 1, wherein the degasser shaft comprises:
a total length of between 250 and 600 mm;
a first constant section segment comprising a length in the range of 50 to 100 mm;
a tapered segment abutting the first constant section segment comprising an external diameter which decreases as the tapered segment extends towards the second end, said tapered segment comprising an axial length in the range of 100 to 400 mm;
an optional second constant section segment;
a first shaft end external diameter in the range of 60 to 90 mm;
a second shaft end external diameter in the range of 45 to 70 mm; and
a passage diameter in the range of 10 to 25 mm.

24-28. (canceled)

29. The degasser shaft according to claim 1, wherein the maximum wall thickness (Wallₘₐₓ) of the degasser shaft is located at or towards where the degasser shaft has the maximum external diameter and the minimum wall thickness (Wallₘᵢₙ) of the degasser shaft is located at or towards the second end and wherein the ratio of Wallₘᵢₙ/Wallₘₐₓ is in the range of 0.75 to 0.95.

30-36. (canceled)

37. A process for degassing a molten metal melt comprising submerging a degassing apparatus into the molten metal melt, said degassing apparatus comprising a degassing shaft according to claim 1.

38. (canceled)

39. A process according to claim 37, wherein a surface of the molten metal melt meets the degasser shaft at a melt line positioned at an external diameter of the degasser shaft is greater than the minimum shaft external diameter and wherein the degasser shaft wall thickness at the melt line is greater than at a minimum shaft wall thickness below the melt line.

40-41. (canceled)
